(19) United States
(12) Patent Application Publication
(10) Pub. No.: US 2013/0211951 A1
(43) Pub. Date: Aug. 15, 2013

(54) SELF LEARNING GIFT RECOMMENDATION ENGINE

(71) Applicants: Pavel Kalinin, San Mateo, CA (US); Ilya Milman, San Francisco, CA (US)

(72) Inventors: Pavel Kalinin, San Mateo, CA (US); Ilya Milman, San Francisco, CA (US)

(73) Assignee: WAL-MART STORES, INC., Bentonville, AR (US)

(21) Appl. No.: 13/369,816

(22) Filed: Feb. 9, 2012

(51) Int. Cl. G06Q 30/06; G06F 15/18

(52) U.S. Cl. 705/26.7

(57) ABSTRACT

Disclosed herein are methods and apparatus for operating a self learning gift recommendation engine in an electronic medium to facilitate the selection of gifts by a gift shopper for a prospective gift receiver. In one example, a method comprises presenting the gift shopper with at least one question from a questions repository through an interface of an electronic device, receiving a response from the gift shopper to the at least one question, presenting the gift shopper with a recommendation for at least one gift, receiving an indication from the gift shopper of the desirability of the at least one gift, analyzing data regarding the at least one question presented, the response received, and the indication received to asses one of the effectiveness and the efficiency of the at least one question presented in facilitating the selection of the gift, and recording an indication of the assessment in a knowledge repository.

### BACKGROUND OF INVENTION

Aspects and embodiments of the present invention are directed generally to the field of electronic commerce. More specifically, various aspects and embodiments of the present invention are directed to methods and apparatus for operating a self learning gift recommendation engine in an electronic medium to facilitate the selection of gifts by a prospective gift giver for a prospective gift receiver.

### SUMMARY OF INVENTION

In accordance with an aspect of the present invention, there is provided a computer-implemented method for facilitating the selection of a gift by a gift shopper for a gift receiver. The method comprises presenting the gift shopper with at least one question from a questions repository through an interface of an electronic device, receiving a response from the gift shopper to the at least one question, presenting the gift shopper with a recommendation for at least one gift, receiving an indication from the gift shopper of the desirability of the at least one gift, analyzing data regarding the at least one question presented, the response received, and the indication received to asses one of the effectiveness and the efficiency of the at least one question presented in facilitating the selection of the gift, and recording an indication of the assessment in a knowledge repository.

In accordance with some embodiments the at least one gift is selected from an item repository based at least in part upon the response.

In accordance with some embodiments a set of questions in the question repository is amended based on the assessment.

In accordance with some embodiments, the method further comprises presenting a set of answers to the at least one question to the gift shopper, wherein the response comprises an indication of a selection of an answer from the set of answers by the gift shopper.

In accordance with some embodiments the set of answers are amended based on the assessment.

In accordance with some embodiments the recommendation for the at least one gift is amended based on the assessment.

In accordance with some embodiments responsive to receiving an indication from the gift shopper on an undesirability of the at least one gift, the gift shopper is presented with at least one additional question from the questions repository.

In accordance with some embodiments the method further comprises presenting the gift shopper with a recommendation for at least one additional gift.

In accordance with some embodiments the at least one additional gift is selected from the item repository based at least in part upon the response and an additional response to the at least one additional question.

In accordance with some embodiments the method further comprises amending one of the recommendation for the at least one gift, the set of questions in the question repository, and a set of answers to the at least one question based on an indication by the gift shopper of the desirability of the at least one additional gift.

In accordance with some embodiments the method further comprises causing the at least one gift to be shipped to one of the gift shopper and the gift receiver.

In accordance with some embodiments the method further comprises amending one or more of the recommendation for the at least one gift, the set of questions in the question repository, and a set of answers to the at least one question based on feedback from the gift shopper regarding information about the gift receiver.

In accordance with another aspect, there is provided a system facilitating the selection of a gift by a gift shopper for a gift receiver. The system comprises an interface and a processor coupled to the interface. The processor is configured to present the gift shopper with at least one question from a questions repository, receive a response from the gift shopper to the at least one question, present the gift shopper with a recommendation for at least one gift, receive an indication from the gift shopper regarding the desirability of the at least one gift, analyze data regarding the at least one question presented, the response received, and the indication received to asses one of the effectiveness and the efficiency of the at least one question presented in facilitating the selection of the gift, and store, on a storage device, an indication of the assessment.

In accordance with some embodiments the processor is further configured to amend a set of questions in the question repository based on the assessment.

In accordance with some embodiments the processor is further configured to amend a set of answers to the at least one question presented to the gift shopper based on the assessment.

In accordance with some embodiments the processor is further configured to amend the recommendation for the at least one gift based on the assessment.

In accordance with some embodiments the processor is further configured to cause the at least one gift to be shipped to one of the gift shopper and the gift receiver.

In accordance with another aspect, there is provided a computer readable medium having stored thereon sequences of instruction including instructions that will cause a processor to present a gift shopper with at least one question from a questions repository, receive a response from the gift shopper to the at least one question, present the gift shopper with a recommendation for at least one gift, receive an indication from the gift shopper regarding the desirability of the at least one gift, analyze data regarding the at least one question presented, the response received, and the indication received to asses one of the effectiveness and the efficiency of the at least one question presented in facilitating the selection of the gift, and store, on a storage device, an indication of the assessment.

In accordance with some embodiments the instructions will further cause the processor to amend one of a set of questions in the question repository, a set of answers to the at least one question, and the recommendation for the at least one gift based on the assessment.

In accordance with some embodiments the instructions will further cause the processor to cause the at least one gift to be shipped to one of the gift shopper and the gift receiver.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a block diagram of one example of a computer system with which various aspects in accord with the present invention may be implemented;

FIG. 2 is functional diagram of a computer system with which various aspects to in accord with the present invention may be implemented;

FIG. 3 is a flowchart of a process in accordance with one example;

FIG. 4 is a an example of an welcome screen in accordance with one example;

FIG. 5 is an example of an initial query presented in accordance with one example;

FIG. 6 is an example of a question presented in accordance with one example;

FIG. 7 is an example of a set of gift recommendations presented in accordance with one example;

FIG. 8 is an example of a question presented in accordance with one example;

FIG. 9 is an example of a question presented in accordance with one example;

FIG. 10 is an example of a set of gift recommendations presented in accordance with one example; and

FIG. 11 is an example of a feedback solicitation in accordance with one example.

### DETAILED DESCRIPTION

This invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of “including,” “comprising,” “having,” “containing,” “involving,” and variations thereof herein is meant to encompass the items listed thereafter and equivalents thereof as well as additional items.

The gift recommendation software (also referred to herein as “gift recommendation systems” or “gift recommendation engines”) of many electronic commerce (e-commerce) web sites are either based on categories or on a set of pre-defined static questions. The depth of these questions or categories is often fixed and a same set of questions or categories are offered to all shoppers. At least some aspects and embodiments of the present invention provide for a more agile way for a gift recommendation system to facilitate a gift search that interactively guides gift shoppers through the gift selection. In accordance with some aspects and embodiments disclosed herein, a gift recommendation engine collects information that is specific to each individual gift shopper. In accordance with some aspects and embodiments disclosed herein, a gift recommendation engine learns from the shopping experience of gift shoppers. This learning aspect provides for aspects and embodiments of the gift recommendation engine to improve the relevance of gift recommendation each time the new data is received from a gift shopper using the gift recommendation engine.

In at least some embodiments, the gift recommendation engine presents a gift shopper with a series of questions or images. After answering the series of questions (or clicking on the images), the shopper may be presented with a set of gift ideas. The shopper may select a gift from the set of gift ideas to purchase. If the gift shopper does not decide to purchase one of the presented gifts, the gift recommendation engine may present additional questions or images to further refine the recommended set of gifts. This repetitive process can run virtually indefinitely, until the shopper finds the right gift or decides to exit the application. At each step, the gift shopper's answers may be compared to the answers of other shoppers who have successfully found their gift. A gift shopper will be leveraging the gift ideas of other people who have previously used the application. Thus the efficiency of a gift search using the gift recommendation engine and the relevancy of gift recommendations will constantly improve as additional gift shoppers use the gift recommendation engine.

In different embodiments, the gift recommendation can be added to current e-commerce web sites, can be developed as a stand alone web application, a mobile application, or an application hosted on social networking sites.

### Computer System

Various aspects and functions described herein in accordance with the present embodiments may be implemented as hardware or software on one or more computer systems or electronic devices. There are many examples of computer systems currently in use. These examples include, among others, network appliances, personal computers, workstations, mainframes, networked clients, servers, media servers, application servers, database servers, and web servers. Other examples of computer systems may include mobile computing devices, such as cellular phones and personal digital assistants, and network equipment, such as load balancers, routers and switches. Further, aspects in accordance with the present embodiments may be located on a single computer system or may be distributed among a plurality of computer systems connected to one or more communications networks.

For example, various aspects and functions may be distributed among one or more computer systems configured to provide a service to one or more client computers, or to perform an overall task as part of a distributed system. Additionally, aspects may be performed on a client-server or multi-tier system that includes components distributed among one or more server systems that perform various functions. Thus, the embodiments are not limited to executing on any particular system or group of systems. Further, aspects may be implemented in software, hardware or firmware, or any combination thereof. Thus, aspects in accordance with the present embodiments may be implemented within methods, acts, systems, system elements and components using a variety of hardware and software configurations, and the embodiments are not limited to any particular distributed architecture, network, or communication protocol.

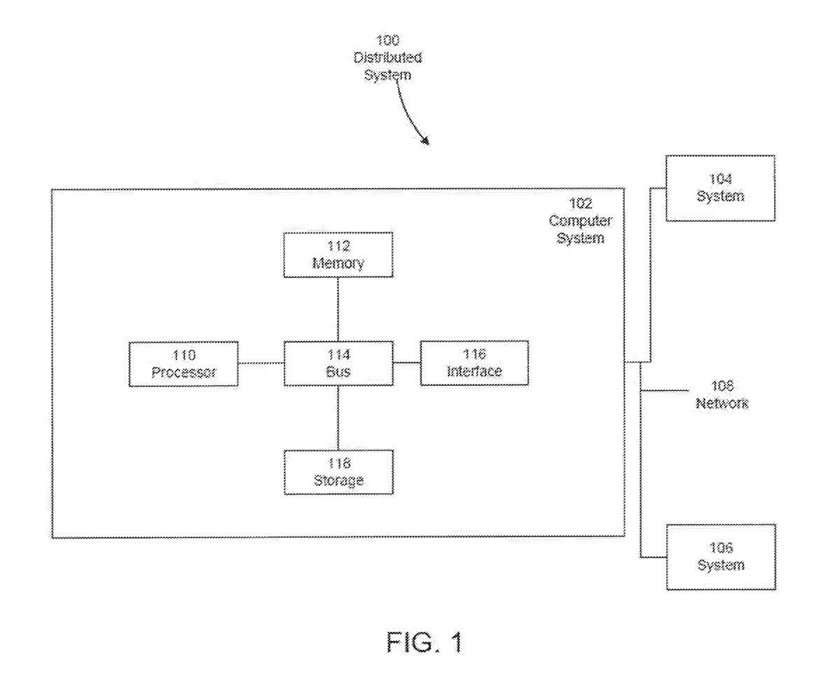

FIG. 1 shows a block diagram of a distributed computer system 100, in which various aspects and functions in accord with the present embodiments may be practiced. Distributed computer system 100 may include one more computer systems. For example, as illustrated, distributed computer system 100 includes computer systems 102, 104, and 106. As shown, computer systems 102, 104, and 106 are interconnected by, and may exchange data through, communication network 108. Network 108 may include any communication network through which computer systems may exchange data. To exchange data using network 108, computer systems 102, 104, and 106 and network 108 may use various methods, protocols and standards, including, among others, token ring, Ethernet, wireless Ethernet, Bluetooth, TCP/IP, UDP, Http, FTP, SNMP, SMS, MMS, SS7, Json, Soap, and Corba. To ensure data transfer is secure, computer systems 102, 104, and 106 may transmit data via network 108 using a variety of security measures including TLS, SSL or VPN among other security techniques. While distributed computer system 100 illustrates three networked computer systems, distributed computer system 100 may include any number of computer systems and computing devices, networked using any medium and communication protocol.

Various aspects and functions in accordance with the present embodiments may be implemented as specialized hardware or software executing in one or more computer systems including computer system 102 shown in FIG. 1. As depicted, computer system 102 includes processor 110, memory 112, bus 114, interface 116, and storage 118. Processor 110 may perform a series of instructions that result in manipulated data. Processor 110 may be a commercially available processor such as an Intel Pentium, Motorola PowerPC, SGI MIPS, Sun UltraSPARC, or Hewlett-Packard PA-RISC processor, but may be any type of processor, multi-processor, microprocessor or controller as many other processors and controllers are available. Processor 110 is connected to other system elements, including one or more memory devices 112, by bus 114.

Memory 112 may be used for storing programs and data during operation of computer system 102. Thus, memory 112 may be a relatively high performance, volatile, random access memory such as a dynamic random access memory (DRAM) or static memory (SRAM). However, memory 112 may include any device for storing data, such as a disk drive or other non-volatile, non-transitory, storage device. Various embodiments in accordance with the present invention may organize memory 112 into particularized and, in some cases, unique structures to perform the aspects and functions disclosed herein.

Components of computer system 102 may be coupled by an interconnection element such as bus 114. Bus 114 may include one or more physical busses, for example, busses between components that are integrated within a same machine, but may include any communication coupling between system elements including specialized or standard computing bus technologies such as IDE, SCSI, PCI, and InfiniBand. Thus, bus 114 enables communications, for example, data and instructions, to be exchanged between system components of computer system 102.

Computer system 102 also includes one or more interface devices 116 such as input devices, output devices, and combination input/output devices. Interface devices may receive input or provide output. More particularly, output devices may render information for external presentation. Input devices may accept information from external sources. Examples of interface devices include keyboards, mouse devices, trackballs, microphones, touch screens, printing devices, display screens, speakers, network interface cards, etc. Interface devices allow computer system 102 to exchange information and communicate with external entities, such as users and other systems.

Storage system 118 may include a computer readable and writeable, nonvolatile, non-transitory, storage medium in which instructions are stored that define a program to be executed by the processor. Storage system 118 also may include information that is recorded, on or in, the medium, and this information may be processed by the program. More specifically, the information may be stored in one or more data structures specifically configured to conserve storage space or increase data exchange performance. The instructions may be persistently stored as encoded signals, and the instructions may cause a processor to perform any of the functions described herein. The medium may, for example, be optical disk, magnetic disk, or flash memory, among others. In operation, the processor or some other controller may cause data to be read from the nonvolatile recording medium into another memory, such as memory 112, that allows for faster access to the information by the processor than does the storage medium included in storage system 118. The memory may be located in storage system 118 or in memory 112, however, processor 110 may manipulate the data within the memory 112, and then may copy the data to the medium associated with storage system 118 after processing is completed. A variety of components may manage data movement between the medium and integrated circuit memory element and the presently described embodiments are not limited thereto. Further, the embodiments are not limited to a particular memory system or data storage system.

Although computer system 102 is shown by way of example as one type of computer system upon which various aspects and functions in accordance with the to present embodiments may be practiced, any aspects of the presently disclosed embodiments are not limited to being implemented on the computer system as shown in FIG. 1. Various aspects and functions in accord with the presently disclosed embodiments may be practiced on one or more computers having a different architectures or components than that shown in FIG. 1. For instance, computer system 102 may include specially-programmed, special-purpose hardware, such as for example, an application-specific integrated circuit (ASIC) tailored to perform a particular operation disclosed herein. While another embodiment may perform the same function using several general-purpose computing devices running MAC OS System X with Motorola PowerPC processors and several specialized computing devices running proprietary hardware and operating systems.

Computer system 102 may be a computer system including an operating system that manages at least a portion of the hardware elements included in computer system 102. Usually, a processor or controller, such as processor 110, executes an operating system which may be, for example, a Windows-based operating system such as Windows NT, Windows 2000 (Windows ME), Windows XP, or Windows Vista operating systems, available from the Microsoft Corporation, a MAC OS System X operating system available from Apple Computer, one of many Linux-based operating system distributions, for example, the Enterprise Linux operating system available from Red Hat Inc., a Solaris operating system available from Sun Microsystems, or a UNIX operating system available from various sources. Many other operating systems may be used, and embodiments are not limited to any particular implementation.

The processor and operating system together define a computer platform for which application programs in high-level programming languages may be written. These component applications may be executable, intermediate, for example, C-, bytecode or interpreted code which communicates over a communication network, for example, the Internet, using a communication protocol, for example, TCP/IP. Similarly, aspects in accord with the presently disclosed embodiments may be implemented using an object-oriented programming language, such as .Net, to SmallTalk, Java, C++, Ada, or C# (C-Sharp). Other object-oriented programming languages may also be used. Alternatively, functional, scripting, or logical programming languages may be used.

Additionally, various aspects and functions in accordance with the presently disclosed embodiments may be implemented in a non-programmed environment, for example, documents created in HTML, XML, or other format that, when viewed in a window of a browser program, render aspects of a graphical-user interface or perform other functions. Further, various embodiments in accord with the present invention may be implemented as programmed or non-programmed elements, or any combination thereof. For example, a web page may be implemented using HTML while a data object called from within the web page may be written in C++. Thus, the presently disclosed embodiments are not limited to a specific programming language and any suitable programming language could also be used.

A computer system included within an embodiment may perform additional functions outside the scope of the presently disclosed embodiments. For instance, aspects of the system may be implemented using an existing commercial product, such as, for example, Database Management Systems such as SQL Server available from Microsoft of Seattle Wash., Oracle Database from Oracle of Redwood Shores, Calif., and MySQL from MySQL AB, a subsidiary of Oracle or integration software such as Web Sphere middleware from IBM of Armonk, N.Y. However, a computer system running, for example, SQL Server may be able to support both aspects in accord with the presently disclosed embodiments and databases for sundry applications.

### Example System Architecture

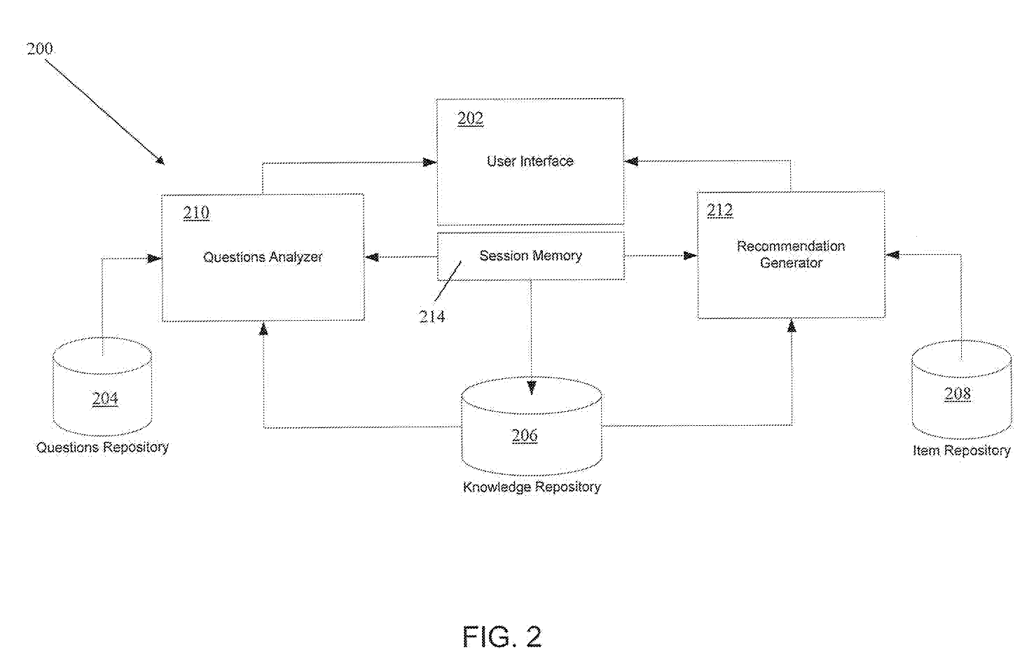

FIG. 2 presents a context diagram including physical and logical elements of a distributed computer system 200. As shown, distributed system 200 is specially configured in accordance with the presently disclosed embodiments. The system structure and content recited with regard to FIG. 2 is for exemplary purposes only and is not intended to limit the embodiments to the specific structure shown in FIG. 2. As to will be apparent to one of ordinary skill in the art, many variant system structures can be architected without deviating from the scope of the presently disclosed embodiments. The particular arrangement presented in FIG. 2 was chosen to promote clarity.

Information may flow between the elements, components, and subsystems depicted in FIG. 2 using any technique. Such techniques include, for example, passing the information over the network via TCP/IP, passing the information between modules in memory and passing the information by writing to a file, database, or some other non-volatile storage device. Other techniques and protocols may be used without departing from the scope of the presently disclosed embodiments.

Referring to FIG. 2, system 200 includes user interface 202, questions repository 204, knowledge repository 206, item repository 208, questions analyzer 210, recommendation generator 212, and session memory 214. System 200 may allow a user, such as a gift shopper, to interact with interface 202 to access the gift recommendation engine to choose a gift for a gift recipient. The features of user interface 202, as may be found in various embodiments in accordance with the present invention, are discussed further below. In at least one embodiment, answers to various queries are entered into system 200 through the user interface 202 by a gift shopper, and recommendations for various gifts are provided to the gift shopper. The user interface may include the interface 116 illustrated in the computer system of FIG. 1.

The questions repository 204 may include various sets of questions or images which may be presented to a gift shopper during a gift search. The item repository 208 may contain information regarding various gifts, for example, images, descriptions, prices, links to add a gift to a virtual shopping cart, etc. The knowledge repository 206 may include information related to the set of questions or images, or combinations of sets of questions or images which may efficiently guide a gift shopper to an appropriate gift. Any or all of the questions repository 204, knowledge repository 206, and item repository 208 may reside in storage 118 of the computer system illustrated in FIG. 1. In some embodiments, the questions repository 204, to knowledge repository 206, and/or item repository 208 may be included in the same physical storage device, and in other embodiments, part or all of one or more of these repositories may reside on a separate storage device from one or more of the others.

The questions analyzer 210 may select questions or images from the questions repository 204 for presentation to a gift shopper and record the responses entered by the gift shopper through the user interface 202. The questions analyzer may communicate with the knowledge repository 206 for guidance regarding a next set of questions or images to present to a gift shopper based on the responses to previously presented questions or images. This communication may take place directly between the questions analyzer 210 and the knowledge repository 206, or through a session memory 214 which may include, for example, at least a portion of memory 112 and/or storage 118 of the computer system of FIG. 1. As explained in more detail below, the questions analyzer 210 may also update one or both of the knowledge repository 206 and the questions repository 204 based on input provided by a gift shopper.

The recommendation generator 212 may communicate with one or both of the questions analyzer 210 or the knowledge repository 206, directly or through session memory 214, to select gift recommendations from the item repository 208 for presentation to a gift shopper. This selection may be guided, at least in part, upon a gift shopper's responses to presented questions or images and data recorded in the knowledge repository regarding gifts which may be appropriated given the gift shopper's responses.

The system components shown in FIG. 2 each may include one or more computer systems. As discussed above with regard to FIG. 1, computer systems may have one or more processors or controllers, memory and interface devices. The particular configuration of system 200 depicted in FIG. 2 is used for illustration purposes only and embodiments of the invention may be practiced in other contexts. Thus, embodiments of the invention are not limited to a specific number of users or systems.

### Gift Selection Engine Operation

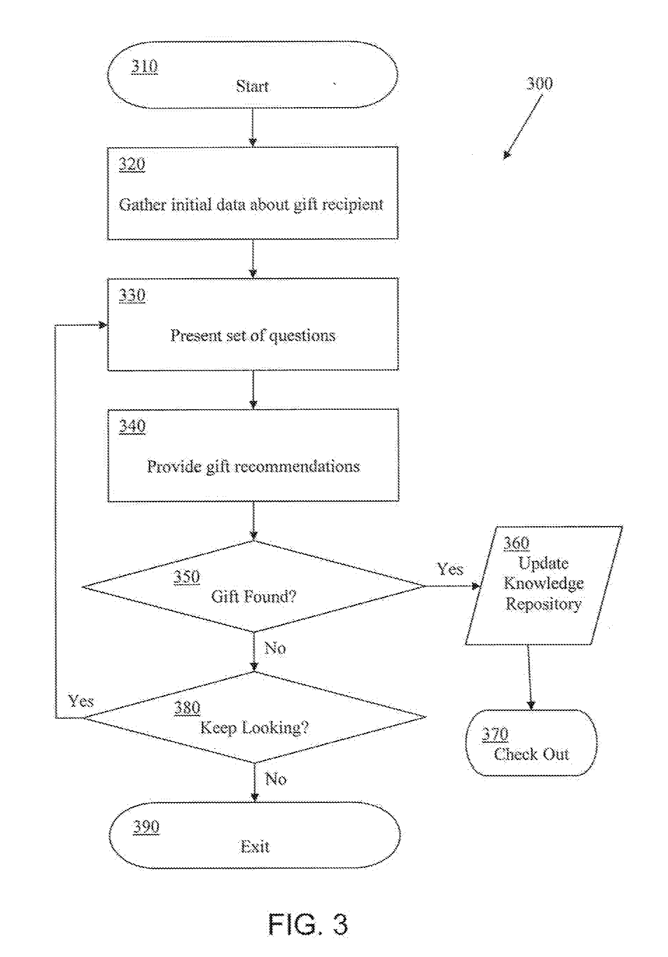

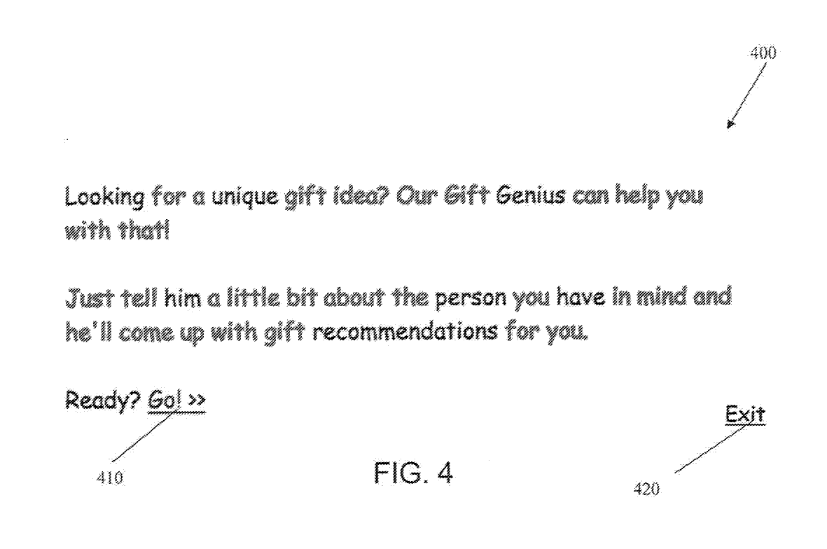

A method in accordance with an embodiment of the present invention is illustrated in FIG. 3, indicated generally at 300. The method begins in act 310 where a gift shopper may access an embodiment of the gift recommendation engine, through, for example, a web site of an e-commerce vendor. The gift recommendation engine may be accessed by, for example, selecting a link to the gift selection engine on a web page of the e-commerce vendor. When accessing the gift recommendation engine, a gift shopper may be presented with a welcome screen 400 as illustrated in FIG. 4. The gift shopper may proceed by mouse clicking a “Go” or “Continue” button or hyperlink 410 or quit by hitting an “Exit” or “Quit” button or hyperlink 420. It should be understood that this welcome screen 400 as well as the example interface presentations in the following figures are only representative of one possible embodiment, and these presentations may be in different forms and/or contain different information in different embodiments.

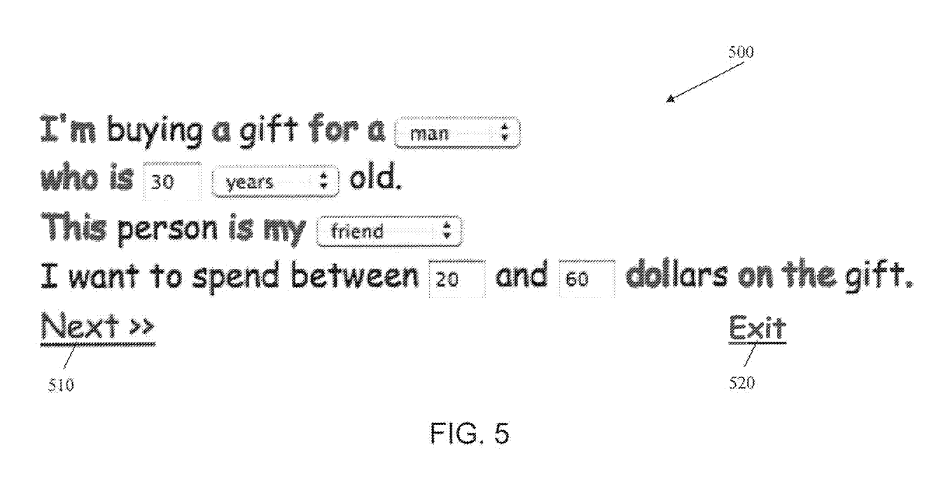

If the gift shopper proceeds to perform a gift search with the gift recommendation engine by, for example, clicking the “Go” or “Continue” button or hyperlink 410, the gift shopper may be presented with a first set of questions, an example set of which is illustrated at 500 in FIG. 5. This first set of questions 500 may query the shopper regarding some initial data about the prospective gift recipient (act 320 of FIG. 3.) This first set of questions may request information regarding, for example, the prospective gift recipient's age, gender, and relationship with the gift shopper. The gift shopper may also be requested to select a price range for a prospective gift. The gift shopper may exit the gift selection engine by clicking an “Exit” or “Quit” button or hyperlink 520, or may answer the questions presented and proceed by clicking a “Next” or “Continue” button or hyperlink 510. In some embodiments, all of the initial questions must be answered before the gift shopper may continue, and in other embodiments one or more of the initial questions may be optional. In some embodiments, the initial set of questions are those which are considered particularly relevant to the selection of a gift for a prospective gift recipient. A ranking of particularly relevant information, or questions which have most quickly led gift shoppers to a desired gift may be maintained in the knowledge repository 206 and/or questions repository 204, and the initial set of questions 500 may be selected based on this ranking.

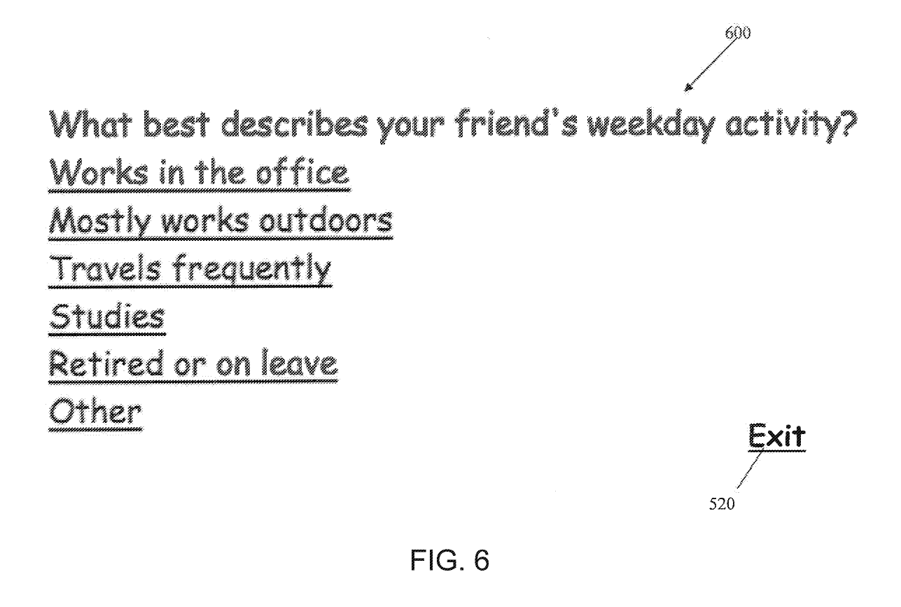

If the gift shopper proceeds past the initial set of questions 500, the gift shopper may be presented with another question or set of questions from, for example, the question repository 204 selected by, for example, the questions analyzer 210 (act 330 of FIG. 3.) An example question is illustrated at 600 in FIG. 6. The selection of the question or set of questions 600 by the questions analyzer 210 may be influenced by the gift shopper's answers to the initial questions 500. For example, the set of questions 600 may refer to the prospective gift recipient as the gift shopper's “friend” if this relationship was indicated by the gift shopper in the answers to the set of questions 500. Further, based on the age of the prospective gift recipient, the questions analyzer 210 may query the knowledge repository 206 to determine if questions regarding the prospective gift recipient's work or school may be appropriate. Questions regarding work and/or school may only be likely to be relevant for prospective gift recipients within a certain age range.

The question or questions 600 may in some embodiments not be limited to text based questions. For example, in some embodiments the gift shopper may be asked to select which, from a set of images of different products, the prospective gift recipient would most likely enjoy, or may be asked to rank images of products for the prospective gift recipient. In other embodiments, the gift shopper may be presented with other forms of questions or images. For example, the gift shopper may be asked to select from a list of text based answers, images, or even video clips or sounds which of the list of text based answers, images, video clips, or sounds best represent some aspect of the prospective gift recipient's personality. For example, the gift shopper may be asked which of the selections best represent the prospective gift recipient's favorite color(s), book(s), movie(s), activity, or music. Thus, as used herein, the term “questions” is not limited to text based questions, but also encompasses queries based on, for example, images, colors, sound, or video.

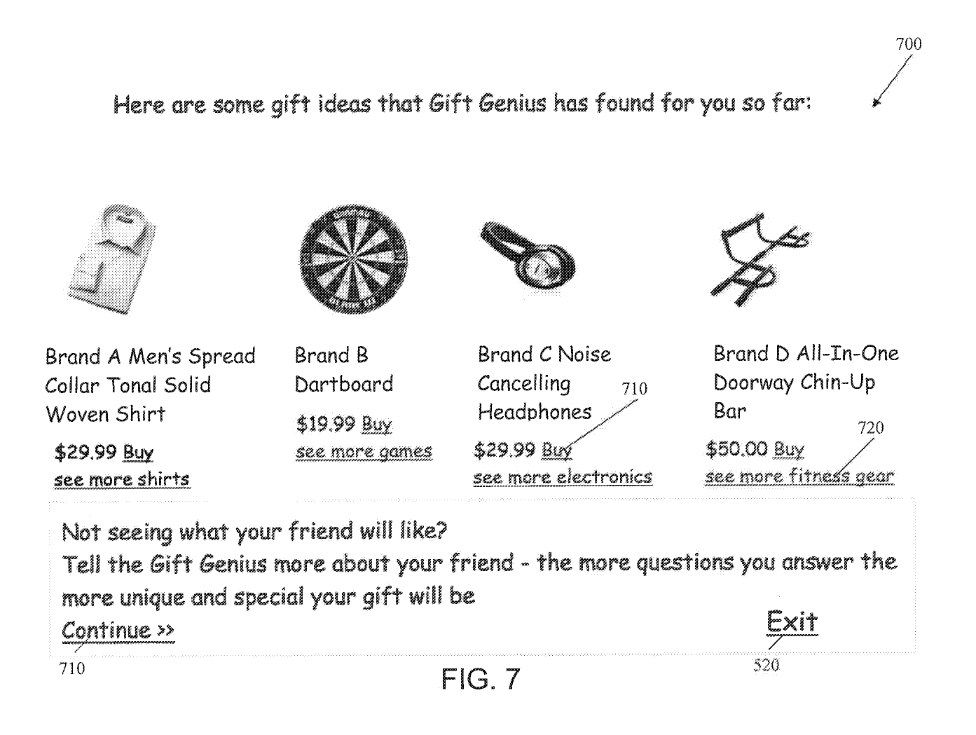

In response to the gift shopper answering the question or questions 600, the gift selection engine may present the gift shopper with a set of gift recommendations (act 340 of FIG. 3.) The gift recommendations may be selected based on the answers to the questions 500 and 600. The gift recommendations may be selected, at least in part, based upon information in the knowledge repository 206 of which gifts or types of gifts were most often chosen by gift shoppers who in the past has answered the questions 500, 600 in a similar manner as the current gift shopper. An example presentation of gift recommendations is illustrated generally at 700 in FIG. 7. In the presentation of gift recommendations, the gift buyer may be offered the option of purchasing one or more of the recommended gifts by selecting a “Buy” or “Purchase” button or hyperlink 710. Selecting this button or hyperlink 710 may add the gift item to the gift buyer's electronic shopping cart, or may bring the gift buyer to a check out window (act 370 of FIG. 3.) Additionally, the knowledge repository 206 may be updated with a record of what answer(s) to what question(s) the gift buyer selected and which gift they chose (act 360 of FIG. 3.) This information may be used to select questions for future gift shoppers which may effectively lead the future gift shoppers to a desirable gift or which may facilitate an efficient search for a desirable gift.

The gift shopper may also be presented with buttons or hyperlinks 720 which may provide for the gift shopper to view other gifts which may be similar to those presented. If the gift shopper views and selects a similar gift, the knowledge repository may be updated with this information. The gift ultimately chosen by the gift shopper may be assigned a higher ranking in the knowledge repository, and may be preferentially presented to future gift shopper s who answer presented questions in a similar manner as the current gift shopper.

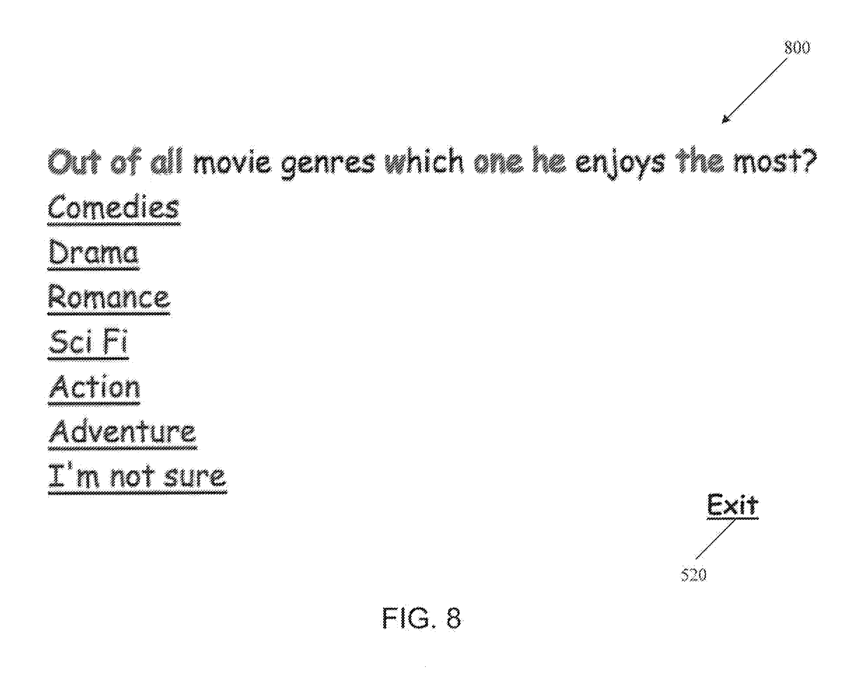

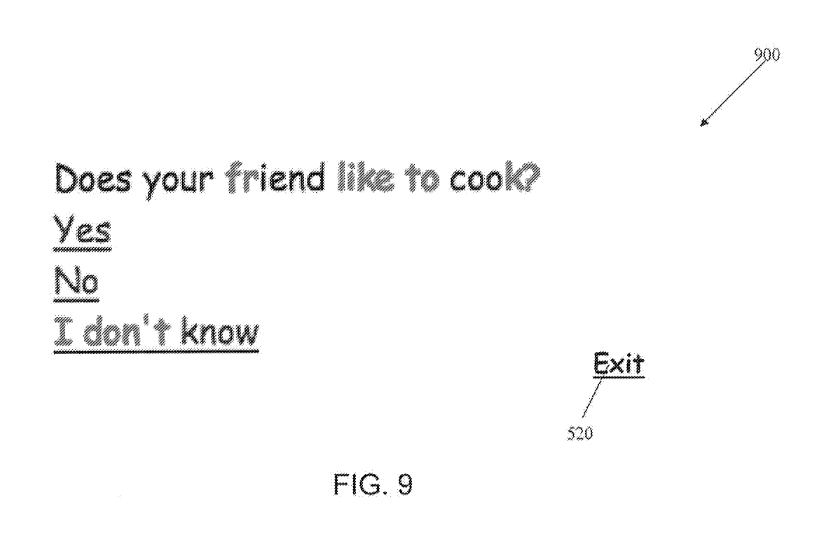

If the gift shopper chooses not to select one of the gift recommendations presented, the gift shopper may choose to keep looking for a gift or to exit the gift recommendation engine (act 380 of FIG. 3.) If the gift shopper chooses to continue searching for a gift, for example by selecting a “Continue” or “Keep Looking” button or hyperlink 710 the method of FIG. 3 returns to act 330 and the gift shopper is presented with another question or set of questions, for, example question 800 illustrated in FIG. 8. In some embodiments, the gift shopper may be presented with one or more additional questions or sets of questions as well, for example, question 900 illustrated in FIG. 9.

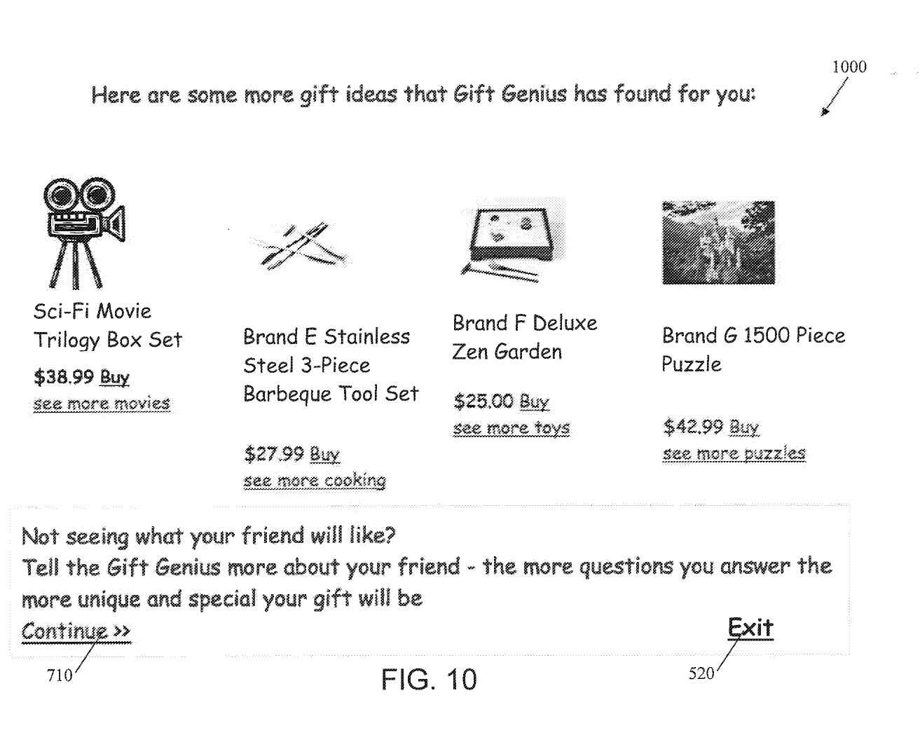

Responsive to the gift shopper selecting answers to one or more of questions or sets of questions 800, 900, the gift shopper may be presented with another set of gift recommendations, for example, the set of gift recommendations 1000 illustrated in FIG. 10. As in the presentation of the set of gift recommendations 700 of FIG. 7, the gift shopper may select one of the gifts from the set of gift recommendations 700 to purchase, may select a button or hyperlink to see gifts which are similar to one or more of the presented recommended gifts, may choose to continue searching for another gift, or may exit the gift recommendation engine. The gift shopper may be presented with additional questions or sets of questions (act 330 of FIG. 3) and gift recommendations based upon answers to those questions or sets of questions (act 340 of FIG. 3) until the gift shopper chooses a gift to purchase or exits the gift recommendation engine (act 390 of FIG. 3.)

After a gift shopper chooses a gift, the questions or sets of questions, and the answers provided to those questions or sets of questions may recorded and the knowledge repository 206 may be updated with an indication of the questions and answers that led to the selection of the chosen gift. In some embodiments, a list of questions and answers that did not result in the gift shopper finding a suitable gift (i.e., that resulted in the gift shopper exiting the gift recommendation engine) is recorded and the knowledge repository is updated with an indication of the questions and answers that did not lead to the selection of a gift.

Questions, or lists of potential answers to questions, may be ranked in the knowledge repository based upon the effectiveness or efficiency of the questions or potential answers in facilitating the search for and selection of a gift by the gift shopper. A measure of efficiency as used herein may be a number of questions that a gift shopper answered prior to choosing a gift. A search having a lower number of questions answered prior to choosing a gift would be considered more efficient than one that included a greater number of questions answered before a gift was chosen. A gift search that resulted in the selection of a gift would be considered more effective than one that did not. Questions included in searches that resulted in a gift shopper exiting the gift recommendation engine before choosing a gift would be considered less effective than questions included in a search that resulting in a gift shopper choosing a gift.

A list of gifts that were chosen in response to presentation to a gift shopper to after answering certain questions in certain ways may also be recorded in the knowledge repository. This information may provide for improvement in gift searches for future users of the gift recommendation engine.

The gift recommendation engine may analyze patterns of what gifts or classes of gifts were selected for purchase responsive to various questions and/or in response to the provision of certain responses to the various questions. For example, the gift recommendation engine may have presented a gift buyer with questions regarding a prospective gift receiver through which the gift buyer indicated that the prospective gift receiver was a teenage boy who liked sports. The gift recommendation engine may have responded by providing a list of recommended gifts including kitchenware, clothing, a sports related item such as a football or basketball, and sports themed video games. Gift shoppers who were searching for gifts may select the sports related item or the sports themed video games more often for prospective gift recipients who were teenage boys who liked sports than the other items presented. The gift recommendation engine might respond by, in the future, presenting more of these types of items rather than the kitchenware or clothing items in response to queries indicating a prospective gift receiver was a teenage boy who liked sports.

Answers to a particular question that were rarely if ever selected, or alternatively, that were always or almost always selected, might be considered to be less efficient and/or effective in facilitating the selection of a gift than answers to the question that were selected on a more of less frequent basis and that helped differentiate between sets of potential gifts. For example, if a question “What sport does your friend prefer?” had an answer “gator wrestling” that was never selected, but answers “baseball” and “football” which were each selected by a large number of gift shoppers, the answer “gator wrestling” might be eliminated from the pool of answers. Similarly, if a particular question always generated the same response, this response might not be considered useful in differentiating between the merits of different possible gift recommendations. The non-useful response, or the question including the non-useful response could then be eliminated or presented less frequently.

Gift recommendations that were often chosen, or gifts that were chosen after a gift shopper viewed a selection of similar gifts as a presented gift recommendation to could be ranked higher in a list of gifts than non-selected gifts in the set of gift recommendations. For example, if a set of gift recommendations included a various electronic devices including an MP3 player, a DVD player, and a VCR, and the VCR was rarely selected, the VCR might be ranked lower and displayed less often in a set of gift recommendations in the future. In another example, if gift shoppers who were presented with a list of gift recommendations including various electronic devices tended to select a link to view more items similar to a presented MP3 player and then choose a particular alternate MP3 player to purchase, the alternate MP3 player could be presented in the list of gift recommendations more often in the future.

Embodiments of the gift recommendation engine may also incorporate externally generated rankings, for example, rankings based on product margin, new products introductions, seasonal demand, item popularity and review ratings, which may influence which products are presented to a gift shopper in a set of gift recommendations. Embodiments of the gift recommendation engine may also incorporate a randomization function to vary which products are presented to gift shoppers in sets of gift recommendations or to introduce new products into the item repository.

In some embodiments, one or more questions and/or one or more responses presented in a list of selectable responses to a question might be selected for presentation to a gift shopper in an at least partially random manner from the question repository for gift shoppers using the gift recommendation engine. This might provide the gift recommendation engine with more data regarding what questions and/or responses were more effective or efficient for facilitating the selection of a gift than if the same questions and potential responses were always presented. For example, one gift shopper may be presented with a question having potential responses A, B, C, and D in act 330 of the method of FIG. 3 after initial data about the gift recipient was gathered in act 320 of FIG. 2. A subsequent gift shopper who provided the same initial data about a gift recipient in act 320 of FIG. 2 may be presented with the same question, but having potential responses A, B, C, and E, or may be presented with a different question.

In some embodiments, the gift recommendation engine would periodically to perform an analysis of the various questions, responses, and gifts selected (and/or failures to locate a gift) by gift shoppers to determine correlations between questions, responses, and gift recommendations which could be used to improve the efficiency or effectiveness of a gift search. The analysis could include, for example, a statistical regression analysis on what questions and/or responses and/or gift recommendations were more likely to result in a gift shopper choosing a gift when presented in a search and/or what questions and/or responses and/or gift recommendations were more likely to result in a more efficient or effective search when presented. The effect of various questions and/or responses and/or gift recommendations on the effectiveness or efficiency of gift searches could also be analyzed by various machine learning or artificial intelligence methods known in the art. In some embodiments, a neural network based learning algorithm is utilized to perform the analysis. The knowledge repository 206, question repository 204, and/or item repository 208 could be updated based on the analysis to produce more efficient or effective gift searches in the future.

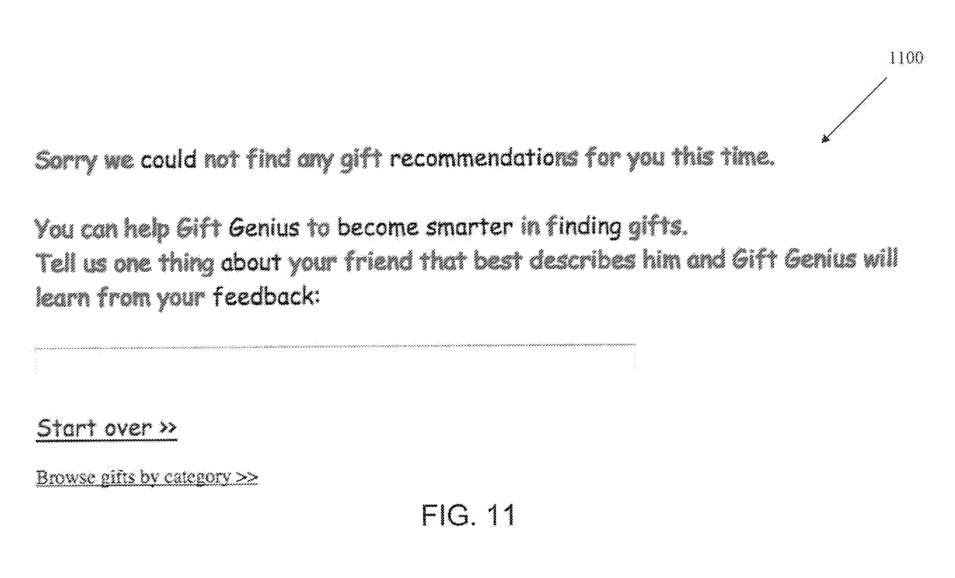

In some embodiments, additional questions and/or potential responses could be generated based at least in part upon feedback from gift shoppers. In one example, if a prospective gift shopper exited the gift recommendation engine prior to selecting a gift (act 390 of FIG. 3), the prospective gift shopper may be asked for feedback on what type of information regarding the prospective gift recipient may have provided the gift recommendation engine with data that would have further facilitated the gift search or made the search more effective or efficient. In one example, indicated at 1100 if FIG. 11, the gift recommendation engine may request the gift shopper describe a characteristic of the prospective gift recipient which the gift recommendation engine could have used in searching for a gift. This feedback could be used to fashion additional questions and/or responses that could be used in future searches. These additional questions and/or responses could be generated by an operator of the gift recommendation engine, or could be generated by the gift recommendation engine itself using, for example, natural language analysis of the feedback provided.

In some embodiments, all gift shoppers using the gift recommendation engine (or a subset thereof), even those who did not successfully find a gift to purchase, to could be presented with a request for feedback. The feedback could be in the form of, for example, the request illustrated in FIG. 11, or in some other form, for example, a survey requesting feedback as to what questions and/or responses were most or least useful in narrowing the gift search and/or what other questions and/or responses may have been useful. The feedback request could presented on a display of an electronic device through which the user accessed the gift recommendation engine responsive to completion or abandonment of a gift search, or could be provided to a gift shopper at a later time, for example through an e-mail or through a physical postcard sent through the mail. The feedback could be used to amend one or more of a set of questions, a set of answers, and a set of recommended gifts presented to future gift shoppers to improve one of the efficiency and the effectiveness of the gift search.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A computer-implemented method for facilitating the selection of a gift by a gift shopper for a gift receiver, the method comprising:
presenting the gift shopper with at least one question from a questions repository through an interface of an electronic device;
receiving a response from the gift shopper to the at least one question;
presenting the gift shopper with a recommendation for at least one gift;
receiving an indication from the gift shopper of the desirability of the at least one gift;
analyzing data regarding the at least one question presented, the response received, and the indication received to asses one of the effectiveness and the efficiency of the at least one question presented in facilitating the selection of the gift; and
recording an indication of the assessment in a knowledge repository.

2. The method of claim 1, wherein the at least one gift is selected from an item repository based at least in part upon the response.

3. The method of claim 2, wherein a set of questions in the question repository is amended based on the assessment.

4. The method of claim 2, further comprising presenting a set of answers to the at least one question to the gift shopper, wherein the response comprises an indication of a selection of an answer from the set of answers by the gift shopper.

5. The method of claim 4, wherein the set of answers are amended based on the assessment.

6. The method of claim 2, wherein the recommendation for the at least one gift is amended based on the assessment.

7. The method of claim 1, wherein responsive to receiving an indication from the gift shopper on an undesirability of the at least one gift, the gift shopper is presented with at least one additional question from the questions repository.

8. The method of claim 7, further comprising presenting the gift shopper with a recommendation for at least one additional gift.

9. The method of claim 8, wherein the at least one additional gift is selected from to the item repository based at least in part upon the response and an additional response to the at least one additional question.

10. The method of claim 9, further comprising amending one of the recommendation for the at least one gift, the set of questions in the question repository, and a set of answers to the at least one question based on an indication by the gift shopper of the desirability of the at least one additional gift.

11. The method of claim 1, further comprising causing the at least one gift to be shipped to one of the gift shopper and the gift receiver.

12. The method of claim 1, further comprising amending one or more of the recommendation for the at least one gift, the set of questions in the question repository, and a set of answers to the at least one question based on feedback from the gift shopper regarding information about the gift receiver.

13. A system facilitating the selection of a gift by a gift shopper for a gift receiver, the system comprising:
an interface; and
a processor coupled to the interface and configured to:
present the gift shopper with at least one question from a questions repository;
receive a response from the gift shopper to the at least one question;
present the gift shopper with a recommendation for at least one gift;
receive an indication from the gift shopper regarding the desirability of the at least one gift;
analyze data regarding the at least one question presented, the response received, and the indication received to asses one of the effectiveness and the efficiency of the at least one question presented in facilitating the selection of the gift; and
store, on a storage device, an indication of the assessment.

14. The system of claim 13, wherein the processor is further configured to amend a set of questions in the question repository based on the assessment.

15. The system of claim 13, wherein the processor is further configured to amend a set of answers to the at least one question presented to the gift shopper based on the assessment.

16. The system of claim 13, wherein the processor is further configured to amend the recommendation for the at least one gift based on the assessment.

17. The system of claim 13, wherein the processor is further configured to cause the at least one gift to be shipped to one of the gift shopper and the gift receiver.

18. A computer readable medium having stored thereon sequences of instruction including instructions that will cause a processor to:
present a gift shopper with at least one question from a questions repository;
receive a response from the gift shopper to the at least one question;
present the gift shopper with a recommendation for at least one gift;
receive an indication from the gift shopper regarding the desirability of the at least one gift;
analyze data regarding the at least one question presented, the response received, and the indication received to asses one of the effectiveness and the efficiency of the at least one question presented in facilitating the selection of the gift; and
store, on a storage device, an indication of the assessment.

19. The computer readable media of claim 18, wherein the instructions will further cause the processor to amend one of a set of questions in the question repository, a set of answers to the at least one question, and the recommendation for the at least one gift based on the assessment.

20. The computer readable media of claim 18, wherein the instructions will further cause the processor to cause the at least one gift to be shipped to one of the gift shopper and the gift receiver.
